(19) United States
(12) Patent Application Publication
(10) Pub. No.: US 2024/0407958 A1
(43) Pub. Date: Dec. 12, 2024

(54) Motorized Chair Assist Device

(71) Applicant: LaTrenna Huey, Claremore, OK (US)

(72) Inventor: LaTrenna Huey, Claremore, OK (US)

(21) Appl. No.: 18/731,768

(22) Filed: Jun. 3, 2024

Related U.S. Application Data
(60) Provisional application No. 63/506,927, filed on Jun. 8, 2023.

(51) Int. Cl. A61G 5/04; A61G 5/10; A61G 5/12; A61G 7/10

(52) U.S. Cl. CPC A61G 5/04; A61G 5/1059; A61G 5/125; A61G 5/128; A61G 7/1019; A61G 7/1025; A61G 7/1048; A61G 2203/12

(57) ABSTRACT

A motorized chair assist device is disclosed that helps caregivers transfer patients or users into their bed or into another chair. The motorized chair assist device comprises a base component with multiple wheels and a footrest component. Further, a seat component, a backrest component and a pair of armrest components are secured to the base component. The device can flatten out and raise the seat component upwards to match the level of the bed or exam table. Additionally, users can raise the seat component and slide it horizontally for transferring the patient to a level surface like a bed or exam table. Further, the armrest components can retract downwards, like a window for the seat component to slide across toward a table or bed. The multiple wheels provide for smooth movement over various terrain. The device also includes a remote control to control the device.

### CROSS-REFERENCE TO RELATED APPLICATION

The present application claims priority to, and the benefit of, U.S. Provisional Application No. 63/506,927, which was filed on Jun. 8, 2023, and is incorporated herein by reference in its entirety.

### FIELD OF THE INVENTION

The present invention relates generally to the field of motorized chair assist devices. More specifically, the present invention relates to an improved wheelchair with multiple retracting and expanding components that make it easier for caregivers to transfer patients to chairs and beds. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in motorized chair assist devices. Generally, lifting and transferring patients from a wheelchair to a chair or bed, and vice versa, can be a difficult task for caregivers. A significant strain is placed on the caregiver to lift a person out of their wheelchair and onto another surface. Further, patients may be at risk for being dropped and ultimately suffer serious injuries during such activities.

Additionally, there are times when wheelchair users need to perform other tasks at home, which require the user to be at various heights, such as cooking or using the bathroom. At such times if a wheelchair is available that allows users to freely adjust the seat to any height while supporting their body weight, they can perform the aforementioned tasks and this will make them not only more independent in managing their daily lives but also make possible social rehabilitation.

Accordingly, there is a demand for an improved motorized chair assist device that provides for multiple retracting and expanding components that make it easier for caregivers to transfer patients to chairs and beds. More particularly, there is a demand for a motorized chair assist device that maintains comfort for the patient while being transferred by ensuring they can remain seated in a comfortable wheelchair for the entire transferring process.

Therefore, there exists a long felt need in the art for a motorized chair assist device that provides users with an improved wheelchair with multiple retracting and expanding components that make it easier for caregivers to transfer patients to chairs and beds. There is also a long felt need in the art for a motorized chair assist device that relieves significant strain and stress on a caregiver's knees and back, eliminating the need for he or she to utilize their entire body weight to move a patient. Further, there is a long felt need in the art for a motorized chair assist device that maintains comfort for the patient while being transferred by ensuring they can remain seated in a comfortable wheelchair for the entire transferring process. Moreover, there is a long felt need in the art for a device that allows the seat to raise upward to match the height of the bed or chair, along with the chair arms folding flat for a smooth and convenient transfer. Further, there is a long felt need in the art for a motorized chair assist device that includes a detachable remote control for added convenience when transferring patients. Finally, there is a long felt need in the art for a motorized chair assist device that includes multiple wheels for smooth movement over various terrain.

The subject matter disclosed and claimed herein, in one embodiment thereof, comprises a motorized chair assist device. The device is a remote-controlled wheelchair capable of retracting and inclining different components of the chair to help caregivers transfer patients or users into their bed or into another chair. The motorized chair assist device comprises a base component with multiple wheels and a footrest component. Further, a seat component, a backrest component and a pair of armrest components are secured to the base component. The device can flatten out and raise the seat component upwards to match the level of the bed or exam table. Additionally, users can raise the seat component and slide it horizontally for transferring the patient to a level surface like a bed or exam table. Further, the armrest components can retract downwards, like a window for the seat component to slide across toward a table or bed. The multiple wheels provide for smooth movement over various terrain. The device also includes a remote control present on or near the armrest components, which can be used to control the device. The remote control may also be detachable for further convenience. Accordingly, the device makes transfer tasks easier for a caregiver. The device also accounts for the comfortability of the patient during these movements.

In this manner, the motorized chair assist device of the present invention accomplishes all of the forgoing objectives and provides users with a device that helps caregivers transfer patients to chairs and beds. The device is a motorized wheelchair with a seat component that raises and lowers. The device can comprise a plurality of wheels and remote control.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized chair assist device. The device is a remote-controlled wheelchair capable of retracting and inclining different components of the chair to help caregivers transfer patients or users into their bed, on an exam table, or into another chair. The motorized chair assist device comprises a base component with multiple wheels. Further, a seat component, a backrest component and a pair of armrest components are secured to the base component. The device can flatten out and raise the seat component upwards to match the level of the bed, chair, or exam table. Additionally, users can raise the seat component and slide it horizontally for transferring the patient to a level surface. Further, the armrest components can retract downwards, like a window for the seat component to slide across toward a table or bed. The multiple wheels provide for smooth movement over various terrain. The device also includes a remote control, present on or near the armrest components, which can be used to control the device. Accordingly, the device makes transfer tasks easier for a caregiver. The device also accounts for the comfortability of the patient during these movements.

In one embodiment, the motorized chair assist device is made up, at a minimum, of the following components: a base component, rolling mechanisms such as casters/wheels, a seat component, a linear actuator, a control unit which drives the linear actuator, a power source, and a handheld remote control to operate the device. Optional items may be added to create additional functionality or increase safety, as needed.

In one embodiment, the base component is most often formed of tubular aluminum with an outer dimension of approximately two inches, allowing for all portions of the base component to be used as a handhold by either the user (i.e., patient) or the caregiver. In some instances, the base component can be made of different materials such as carbon fiber or steel, or any combination thereof. The bends and corners of the base component are formed in such a way that there are no sharp or protruding edges that might injure the patient or the caregiver during use of the device. The base component has dimensions such that it will fit through a standard residential doorway. All of the components of the device are mounted on the inside of the base component allowing the base component to act as a bumper and guard in the event of a collision with a wall or other external surface.

In one embodiment, the base component comprises a plurality of wheels, casters or other rolling mechanisms. Typically, the base component is mounted above a caster at each corner of the device. The size of the casters can vary, such that the front casters can be smaller than the back casters, or the casters can be all the same size, etc. Each of the four casters has full directional freedom. Optionally, the two rear casters can be restricted such that they will only roll in a direction forward or backward relative to the device. The casters are of such height and width that they will not have trouble traversing items such as small cords, small rocks, or pieces of trash, etc., or other suitable terrain. Typically, the base component comprises two driven rear wheels, one at each side, and a pair of freely rotatable and castering front wheels. At this point attention is directed to the fact that the front wheels are of relatively small diameter (i.e., 8 or 9 inches) as compared with the large diameter rear wheels conventional on wheelchairs. When the present device is being used to lift a patient, all four casters can be locked, ensuring that the device is safe and stable.

In one embodiment, a seat component is secured to the base component. The seat component includes a chair surface with which to lift and safely secure a patient during transport. The device comprises a seat component having a backrest component, both of which are preferably padded and upholstered to be comfortable for long periods of occupancy. Further, armrest components are connected to the seat component to be movable between a raised normal position at the sides of the seat component and a lowered position in which they are positioned below the seat component, so as not interfere with the movements of the seat component. In one embodiment, one of the armrest components comprises a control panel on which are mounted switches, buttons or the like for controlling the powered functions of the motorized chair assist device.

In one embodiment, the seat component is connected to a linear actuator to raise and lower the seat component safely, providing support and guidance during vertical movement. Typically, the linear actuator is housed within a control unit, which acts to drive the linear actuator during use. Further, in another embodiment, a second linear actuator is provided, which allows the seat component to move horizontally, allowing the seat component to move closer to the bed, chair, or exam table, as needed. Both linear actuators are housed within the control unit.

In one embodiment, the pair of armrest components can also be raised and lowered, as needed, to not interfere with motion of the seat component. Typically, the armrest components are in communication with a servo motor, which acts to raise and lower the armrest components, as needed. Typically, the servo motor is also housed within the control unit.

In one embodiment, the bottom of the seat component comprises a footrest component. The footrest component can be any suitable shape and size as is known in the art, as long as the footrest component is able to support both of a user's feet. Specifically, the front wheels of the device are coaxially mounted at opposite sides of the front of the base component, which also comprises the footrest component that projects forwardly beyond the front wheels. Typically, the footrest component is also in communication with a servo motor, which acts to raise and lower the footrest component, as needed, to not interfere with the motion of the seat component.

In another embodiment, instead of a first and second linear actuator, the seat component is secured to a pneumatic or hydraulic pump, which pressurizes a first pneumatic or hydraulic cylinder to raise and lower the seat component in a vertical direction and a second pneumatic or hydraulic cylinder to move the seat component horizontally, as needed. The pneumatic or hydraulic pumps would also be housed within the control unit.

In one embodiment, the device is powered by a direct current power source, such as a battery. An on-board control unit houses the battery and any necessary components to ensure that the first and second linear actuators can be driven by the power source. The direct current power source is housed in the form of a rechargeable battery. In one embodiment, the battery charging mechanism is also housed in the control unit, facilitating case of use for the caregiver. The caregiver has the ability to use the device solely on battery power, or, if the device has been used to the point of battery exhaustion, it can be plugged into a standard 110-volt outlet and used. If for any reason the power sources fail, the seat component can be adjusted with a back-up manual raising/lowering crank system located on the rear of the seat component.

In one embodiment, the control unit also houses a motor, such as an electric motor. The motor is powered by the rechargeable battery and acts to power the pneumatic or hydraulic pumps. The pneumatic or hydraulic pumps then act to pressurize the first and second pneumatic or hydraulic cylinders to raise or lower the seat component, as well as move the seat component horizontally. Further, the motor acts to power the wheels or casters, allowing the device to move back and forth, as desired. In another embodiment, the device can also comprise at least one additional motor, such as a servo motor. The servo motor would also be housed within the control unit and powered by the rechargeable battery. The servo motor acts to raise and lower the armrest components and/or the footrest component, as needed.

In one embodiment, the device is operated using a wired or wireless remote control. The remote control is wired to the control unit, which, in turn, provides the needed power to the linear actuator and/or the motor. The wired remote control has a length of wire long enough such that either the patient or the caregiver can operate it from a seated position on the floor or chair. In an alternative embodiment, the remote control is wireless or detached. The remote control via the control unit allows the user to specify the speed of seat component movement and whether or not it should stop at a predetermined height. It also has functions for the user to specify when to start and stop the vertical and horizontal movement and the direction of seat travel, as desired.

In one embodiment, all portions of the present invention are fully enclosed and able to be quickly and easily wiped down and disinfected.

In one embodiment, the use of the present invention is straightforward. The user is seated within the device and the caretaker wheels the device to a position beside a bed, chair or exam table. If the person cannot get up on the bed, chair or exam table on their own, the seat component of the device can be raised to the level of the exam table, chair, or bed (i.e., seat component is flush with table, bed, or chair level). The caretaker or the user initiates the lifting of the seat component via the remote control, which in turn, lifts the person in an upright position to a desired height. The armrest component and/or the footrest components can also be raised or lowered as needed, such that they are out of the way of the seat component during use. Once at the desired height, the seat component is then moved horizontally over the table, bed, or chair to enable a user to more easily transfer to the desired surface. Once in position, the seat component is held stationary while the person is easily transferred from the device to the table, bed, or chair. Once properly situated on the desired surface, the seat component can be moved back into place and the device moved out of the way.

In yet another embodiment, the motorized chair assist device comprises a plurality of indicia.

In yet another embodiment, a method of lifting and transferring patients from a wheelchair to a bed or exam table is disclosed. The method includes the steps of providing a motorized chair assist device comprising a base component with wheels, armrest component, backrest component, and seat component. The method also comprises moving the device toward a bed or exam table. Further, the method comprises raising the seat component such that it is level with the height of the bed or exam table. The method also comprises lowering the armrest components. The method also comprises sliding the seat component horizontally over the bed or exam table. Finally, the method comprises easily transferring the user from the seat component to the bed or exam table.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the motorized chair assist device of the present invention in accordance with the disclosed architecture;

FIG. 2 illustrates a perspective view of one embodiment of the motorized chair assist device of the present invention showing how the armrest components move up and down in accordance with the disclosed architecture;

FIG. 3 illustrates a perspective view of one embodiment of the motorized chair assist device of the present invention showing the base component in accordance with the disclosed architecture;

FIG. 4 illustrates a perspective view of one embodiment of the motorized chair assist device of the present invention showing the seat component being raised in accordance with the disclosed architecture;

FIG. 5 illustrates a perspective view of one embodiment of the motorized chair assist device of the present invention showing how a user is transferred from the device to an exam table in accordance with the disclosed architecture; and

FIG. 6 illustrates a flowchart showing the method of lifting and transferring patients from a wheelchair to a bed or exam table in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a motorized chair assist device that provides users with an improved wheelchair with multiple retracting and expanding components that make it easier for caregivers to transfer patients to chairs and beds. There is also a long felt need in the art for a motorized chair assist device that relieves significant strain and stress on a caregiver's knees and back, eliminating the need for he or she to utilize their entire body weight to move a patient. Further, there is a long felt need in the art for a motorized chair assist device that maintains comfort for the patient while being transferred by ensuring they can remain seated in a comfortable wheelchair for the entire transferring process. Moreover, there is a long felt need in the art for a device that allows the seat to raise upward to match the height of the bed or chair, along with the chair arms folding flat for a smooth and convenient transfer. Further, there is a long felt need in the art for a motorized chair assist device that includes a detachable remote control for added convenience when transferring patients. Finally, there is a long felt need in the art for a motorized chair assist device that includes multiple wheels for smooth movement over various terrain.

The present invention, in one exemplary embodiment, is a novel motorized chair assist device. The device is capable of retracting and inclining different components of the chair to help caregivers transfer patients or users into their bed or into another chair. The motorized chair assist device comprises a base component with multiple wheels and a footrest component. Further, a seat component, a backrest component and a pair of armrest components are secured to the base component. The device can flatten out and raise the seat component upwards to match the level of the bed or exam table. Additionally, users can raise the seat component and slide it horizontally for transferring the patient to a level surface like a bed or exam table. Further, the armrest components can retract downwards, like a window for the seat component to slide across toward a table or bed. The multiple wheels provide for smooth movement over various terrain. The device also includes a remote control. The present invention also includes a novel method of lifting and transferring patients from a wheelchair to a bed or exam table. The method includes the steps of providing a motorized chair assist device comprising a base component with wheels, armrest component, backrest component, and seat component. The method also comprises moving the device toward a bed or exam table. Further, the method comprises raising the seat component such that it is level with the height of the bed or exam table. The method also comprises lowering the armrest components. The method also comprises sliding the seat component horizontally over the bed or exam table. Finally, the method comprises easily transferring the user from the seat component to the bed or exam table.

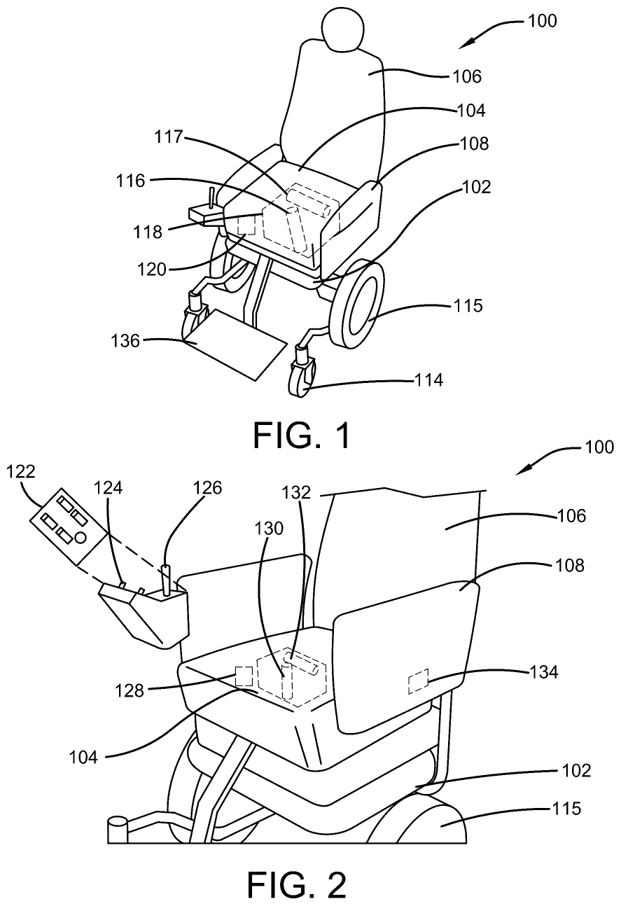

Referring initially to the drawings, FIG. 1 illustrates a perspective view of one embodiment of the motorized chair assist device 100 of the present invention. In the present embodiment, the motorized chair assist device 100 is an improved motorized chair assist device 100 that provides a user 110 with a means for transferring the user 110 to a bed or exam table 112. Specifically, the motorized chair assist device 100 comprises a base component 102 and attached seat component 104, backrest component 106, and pair of armrest components 108. The device 100 can flatten out and raise the seat component 104 upwards to match the level of the bed, chair, or exam table 112. Further, the armrest components 108 can retract downwards, like a window for the seat component 104 to slide across toward a table 112 or bed. Accordingly, the device 100 makes transfer tasks easier for a caregiver. The device 100 also accounts for the comfortability of the patient/user 110 during these movements.

Generally, the motorized chair assist device 100 is made up, at a minimum, of the following components: a base component 102, rolling mechanisms such as casters/wheels 114 and 115, a seat component 104, a linear actuator 116, a control unit 118 which drives the linear actuator 116, a power source 120, and a handheld remote control 122 to operate the device 100. Optional items may be added to create additional functionality or increase safety, as needed.

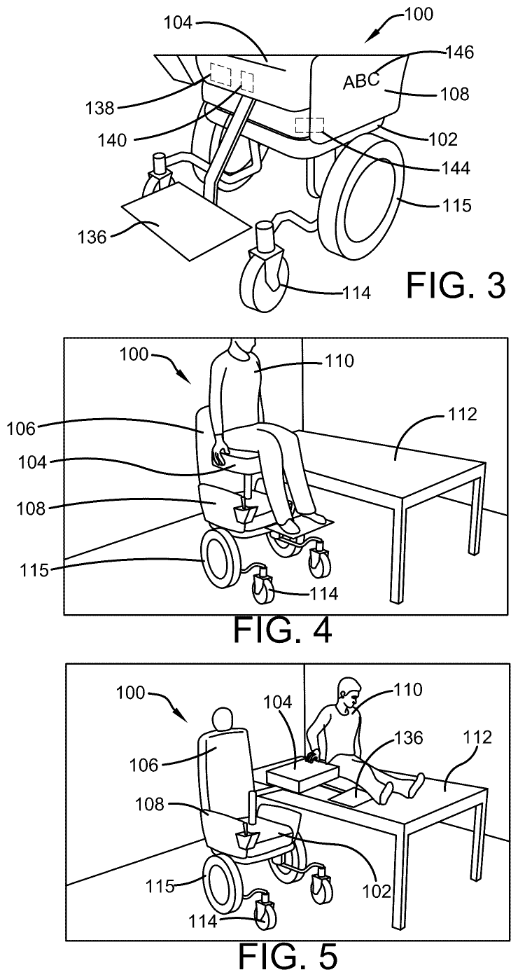

As shown in FIGS. 2-3, the base component 102 is most often formed of tubular aluminum with an outer dimension of approximately two inches, allowing for all portions of the base component 102 to be used as a handhold by either the user 110 (i.e., patient) or the caregiver. In some instances, the base component 102 can be made of different materials such as carbon fiber or steel, or any combination thereof. The bends and corners of the base component 102 are formed in such a way that there are no sharp or protruding edges that might injure the patient 110 or the caregiver during use of the device 100. The base component 102 has dimensions such that it will fit through a standard residential doorway. All of the components of the device 100 are mounted on the inside of the base component 102 allowing the base component 102 to act as a bumper and guard in the event of a collision with a wall or other external surface.

Furthermore, the base component 102 comprises a plurality of wheels 114 and 115, casters or other rolling mechanisms. Typically, the base component 102 is mounted above a caster 114 and 115 at each corner of the device 100. The size of the casters 114 and 115 can vary, such that the front casters 114 can be smaller than the back casters 115, or the casters 114 and 115 can be all the same size, etc. Each of the four casters 114 and 115 has full directional freedom. Optionally, the two rear casters 115 can be restricted such that they will only roll in a direction forward or backward relative to the device 100. The casters 114 and 115 are of such height and width that they will not have trouble traversing items such as small cords, small rocks, or pieces of trash, etc., or other suitable terrain. Typically, the base component 102 comprises two driven rear wheels 115, one at each side, and a pair of freely rotatable and castering front wheels 114. At this point attention is directed to the fact that the front wheels 114 are of relatively small diameter (i.e., 8 or 9 inches) as compared with the large diameter rear wheels 115 conventional on wheelchairs. When the present device 100 is being used to lift a patient 110, all four casters 114 and 115 can be locked, ensuring that the device 100 is safe and stable.

Additionally, a seat component 104 is secured to the base component 102. The seat component 104 includes a chair surface with which to lift and safely secure a patient 110 during transport. The device 100 comprises a seat component 104 having a backrest component 106, both of which are preferably padded and upholstered to be comfortable for long periods of occupancy. Further, armrest components 108 are connected to the seat component 104 to be movable between a raised normal position at the sides of the seat component 104 and a lowered position in which they are positioned below the seat component 104, so as not interfere with the movements of the seat component 104. In one embodiment, one of the armrest components 108 comprises a control panel 124 on which are mounted switches 126, buttons or the like for controlling the powered functions of the motorized chair assist device 100.

Further, the seat component 104 is connected to a linear actuator 116 to raise and lower the seat component 104 safely, providing support and guidance during vertical movement. Typically, the linear actuator 116 is housed within a control unit 118, which acts to drive the linear actuator 116 during use. Further, in another embodiment, a second linear actuator 117 is provided, which allows the seat component 104 to move horizontally, allowing the seat component 104 to move closer to the bed, chair, or exam table 112, as needed. Both linear actuators 116 and 117 are housed within the control unit 118.

In another embodiment, instead of a first 116 and second 117 linear actuator, the seat component 104 is secured to a pneumatic or hydraulic pump 128, which pressurizes a first pneumatic or hydraulic cylinder 130 to raise and lower the seat component 104 in a vertical direction and a second pneumatic or hydraulic cylinder 132 to move the seat component 104 horizontally, as needed. The pneumatic or hydraulic pumps 128 would also be housed within the control unit 118.

Furthermore, the pair of armrest components 108 can also be raised and lowered, as needed, to not interfere with motion of the seat component 104. Typically, the armrest components 108 are in communication with a servo motor 134, which acts to raise and lower the armrest components 108, as needed. Typically, the servo motor 134 is also housed within the control unit 118.

Additionally, the bottom of the seat component 104 comprises a footrest component 136. The footrest component 136 can be any suitable shape and size as is known in the art, as long as the footrest component 136 is able to support both of a user's feet. Specifically, the front wheels 114 of the device 100 are coaxially mounted at opposite sides of the front of the base component 102, which also comprises the footrest component 136 that projects forwardly beyond the front wheels 114. Typically, the footrest component 136 is also in communication with a servo motor 134, which acts to raise and lower the footrest component 136, as needed, to not interfere with the motion of the seat component 104.

Typically, the device 100 is powered by a direct current power source 120, such as a battery 138. An on-board control unit 118 houses the battery 138 and any necessary components to ensure that the first 116 and 117 second linear actuators can be driven by the power source 120. The direct current power source 120 is housed in the form of a rechargeable battery 138. In one embodiment, the battery charging mechanism 140 is also housed in the control unit 118, facilitating ease of use for the caregiver. The caregiver has the ability to use the device 100 solely on battery power, or, if the device 100 has been used to the point of battery exhaustion, it can be plugged into a standard 110-volt outlet and used. If for any reason the power sources 120 fail, the seat component 104 can be adjusted with a back-up manual raising/lowering crank system 142 located on the rear of the seat component 104.

Further, the control unit 118 also houses a motor 144, such as an electric motor. The motor 144 is powered by the rechargeable battery 138 and acts to power the pneumatic or hydraulic pumps 128. The pneumatic or hydraulic pumps 128 then act to pressurize the first 130 and second 132 pneumatic or hydraulic cylinders to raise or lower the seat component 104, as well as move the seat component 104 horizontally. Further, the motor 144 acts to power the wheels 114 and 115 or casters, allowing the device 100 to move back and forth, as desired. In another embodiment, the device 100 can also comprise at least one additional motor, such as a servo motor 134. The servo motor 134 would also be housed within the control unit 118 and powered by the rechargeable battery 138. The servo motor 134 acts to raise and lower the armrest components 108 and/or the footrest component 136, as needed.

In yet another embodiment, the motorized chair assist device 100 comprises a plurality of indicia 146. The seat component 104 of the device 100 may include advertising, a trademark, or other letters, designs, or characters, printed, painted, stamped, or integrated into the seat component 104, or any other indicia 146 as is known in the art. Specifically, any suitable indicia 146 as is known in the art can be included, such as but not limited to, patterns, logos, emblems, images, symbols, designs, letters, words, characters, animals, advertisements, brands, etc., that may or may not be motorized chair, seat, or brand related.

As shown in FIGS. 4-5, in one embodiment, the device 100 is operated using a wired or wireless remote control 122. The remote control 122 is wired to the control unit 118, which, in turn, provides the needed power to the linear actuator 116 and 117 and/or the motor 144. The wired remote control 122 has a length of wire long enough such that either the patient 110 or the caregiver can operate it from a seated position on the floor or chair. In an alternative embodiment, the remote control 122 is wireless or detached. The remote control 122 via the control unit 118 allows the user 110 to specify the speed of seat component movement and whether or not it should stop at a predetermined height. It also has functions for the user 110 to specify when to start and stop the vertical and horizontal movement and the direction of seat travel, as desired.

Further, all portions of the present invention are fully enclosed and able to be quickly and easily wiped down and disinfected.

Generally, the use of the present invention is straightforward. The user 110 is seated within the device 100 and the caretaker wheels the device 100 to a position beside a bed, chair or exam table 112. If the person 110 cannot get up on the bed, chair or exam table 112 on their own, the seat component 104 of the device 100 can be raised to the level of the exam table 112, chair, or bed (i.e., seat component 104 is flush with table 112, bed, or chair level). The caretaker or the user 110 initiates the lifting of the seat component 104 via the remote control 122, which in turn, lifts the person 110 in an upright position to a desired height. The armrest component 108 and/or the footrest components 136 can also be raised or lowered as needed, such that they are out of the way of the seat component 104 during use. Once at the desired height, the seat component 104 is then moved horizontally over the table 112, bed, or chair to enable a user 110 to more easily transfer to the desired surface. Once in position, the seat component 104 is held stationary while the person 110 is easily transferred from the device 100 to the table 112, bed, or chair. Once properly situated on the desired surface, the seat component 104 can be moved back into place and the device 100 moved out of the way.

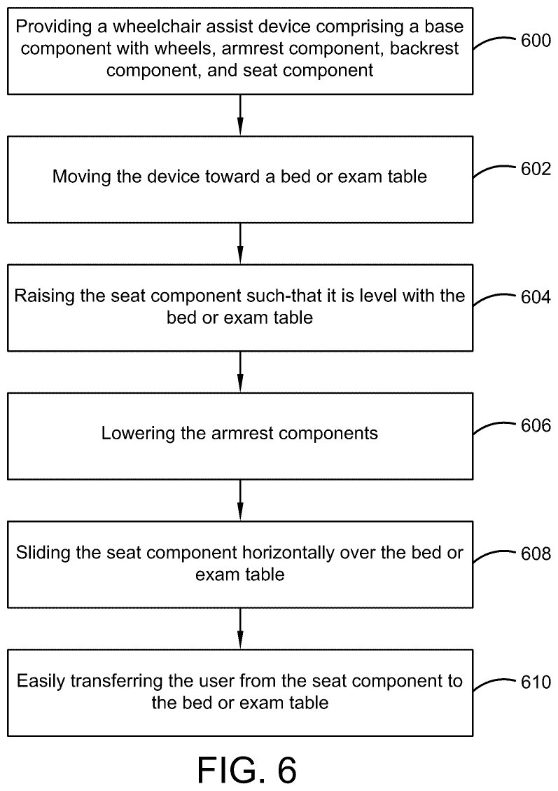

FIG. 6 illustrates a flowchart of the method of lifting and transferring patients from a wheelchair to a bed or exam table. The method includes the steps of at 600, providing a motorized chair assist device comprising a base component with wheels, armrest component, backrest component, and seat component. The method also comprises at 602, moving the device toward a bed or exam table. Further, the method comprises at 604, raising the seat component such that it is level with the height of the bed or exam table. The method also comprises at 606, lowering the armrest components. The method also comprises at 608, sliding the seat component horizontally over the bed or exam table. Finally, the method comprises at 610, easily transferring the user from the seat component to the bed or exam table.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “motorized chair assist device”, “motorized device”, “chair assist device”, and “device” are interchangeable and refer to the motorized chair assist device 100 of the present invention.

Notwithstanding the forgoing, the motorized chair assist device 100 of the present invention can be of any suitable size and configuration as is known in the art without affecting the overall concept of the invention, provided that it accomplishes the above stated objectives. One of ordinary skill in the art will appreciate that the motorized chair assist device 100 as shown in FIGS. 1-6 is for illustrative purposes only, and that many other sizes and shapes of the motorized chair assist device 100 are well within the scope of the present disclosure. Although the dimensions of the motorized chair assist device 100 are important design parameters for user convenience, the motorized chair assist device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized chair assist device that provides a user with a means for transferring a user to a bed or exam table, the motorized chair assist device comprising:
a base component;
a seat component; and
a plurality of wheels;
wherein the seat component includes a backrest component and a pair of armrest components;
wherein the seat component is attached to the base component;
wherein the seat component raises up to a level of an exam table or bed;
wherein the pair of armrest components move downward, so as not impede movement of the seat component; and
further wherein the seat component moves horizontally over the exam table or bed to easily transfer a user from the seat component the exam table or bed.

2. The motorized chair assist device of claim 1, wherein the base component is formed of a tubular aluminum, a carbon fiber or a steel.

3. The motorized chair assist device of claim 2, wherein the plurality of wheels comprises a wheel mounted at each corner of the base component which locks when the seat component is being raised.

4. The motorized chair assist device of claim 3, wherein the front wheels roll in any direction and are smaller than the rear wheels, which roll only forward and backward.

5. The motorized chair assist device of claim 4, wherein the pair of armrest components are movable between a raised normal position at sides of the seat component and a lowered position in which they are positioned below the seat component, so as not to interfere with movements of the seat component.

6. The motorized chair assist device of claim 5, wherein one of the pair of armrest components comprises a control panel on which are mounted switches for controlling powered functions of the motorized chair assist device.

7. The motorized chair assist device of claim 6, wherein the seat component is connected to a first linear actuator to raise and lower the seat component safely, and a second linear actuator for moving the seat component horizontally.

8. The motorized chair assist device of claim 6, wherein the seat component is secured to a pneumatic or hydraulic pump, which pressurizes a first pneumatic or hydraulic cylinder to raise and lower the seat component in a vertical direction and a second pneumatic or hydraulic cylinder to move the seat component horizontally.

9. The motorized chair assist device of claim 6, wherein the pair of armrest components are raised and lowered via a servo motor.

10. The motorized chair assist device of claim 9, wherein the seat component comprises a footrest component that can be raised and lowered as needed via the servo motor.

11. The motorized chair assist device of claim 10, wherein the motorized chair assist device is powered by a direct current power source, such as a rechargeable battery which is positioned within a control unit.

12. The motorized chair assist device of claim 11 further comprising a battery charging mechanism also housed in the control unit.

13. The motorized chair assist device of claim 12 further comprising a back-up manual crank for manually raising or lowering the seat component.

14. The motorized chair assist device of claim 13 further comprising a motor powered by the rechargeable battery to power the pneumatic or hydraulic pumps and the plurality of wheels.

15. A motorized chair assist device that provides a user with a means for transferring a user to a bed or exam table, the motorized chair assist device comprising:
a base component formed of tubular aluminum, carbon fiber, or steel;
a seat component which raises and lowers; and
a plurality of wheels comprising front wheels which roll in any direction and are smaller than the rear wheels, which roll only forward and backward;
wherein the seat component includes a backrest component, a footrest component, and a pair of armrest components;
wherein the pair of armrest components are movable between a raised normal position at sides of the seat component and a lowered position in which they are positioned below the seat component, so as not to interfere with movements of the seat component;
wherein the pair of armrest components and the footrest component are raised and lowered via a servo motor;
wherein one of the pair of armrest components comprises a control panel on which are mounted switches for controlling powered functions of the motorized chair assist device;
wherein the seat component is connected to a first linear actuator to raise and lower the seat component safely, and a second linear actuator for moving the seat component horizontally;
wherein the seat component raises up to a level of an exam table or bed;
wherein the seat component moves horizontally over the exam table or bed to easily transfer a user from the seat component the exam table or bed; and
further wherein the motorized chair assist device is powered by a direct current power source, such as a rechargeable battery and driven by a motor which are both positioned within a control unit.

16. The motorized chair assist device of claim 15 further comprising a plurality of indicia.

17. The motorized chair assist device of claim 15 further comprising a wired remote control for operating the motorized chair assist device functions.

18. The motorized chair assist device of claim 15 further comprising a wireless remote control for operating the motorized chair assist device functions.

19. The motorized chair assist device of claim 15, wherein the seat component is secured to a pneumatic or hydraulic pump, which pressurizes a first pneumatic or hydraulic cylinder to raise and lower the seat component in a vertical direction and a second pneumatic or hydraulic cylinder to move the seat component horizontally.

20. A method of lifting and transferring patients from a wheelchair to a bed or exam table, the method comprising the following steps:
providing a motorized chair assist device comprising a base component with wheels, armrest component, backrest component, and seat component;
moving the device toward a bed or exam table;
raising the seat component such that it is level with the height of the bed or exam table; lowering the armrest components;
sliding the seat component horizontally over the bed or exam table; and
easily transferring the user from the seat component to the bed or exam table.
